(19) United States
(12) Patent Application Publication
(10) Pub. No.: US 2024/0297340 A1
(43) Pub. Date: Sep. 5, 2024

(54) COMPOSITE SOLID ELECTROLYTE AND SOLID-STATE BATTERY

(71) Applicants: Shinya SHIOTANI, Nagoya-shi (JP); Masato TABUCHI, Nagaokakyo-shi (JP)

(72) Inventors: Shinya SHIOTANI, Nagoya-shi (JP); Masato TABUCHI, Nagaokakyo-shi (JP)

(73) Assignees: TOYOTA JIDOSHA KABUSHIKI KAISHA, Toyota-shi (JP); OSAKA SODA CO., LTD., Osaka-shi (JP)

(21) Appl. No.: 18/589,508

(22) Filed: Feb. 28, 2024

(30) Foreign Application Priority Data
Mar. 1, 2023 (JP) 2023-031439

(51) Int. Cl. H01M 10/056; H01M 10/0525

(52) U.S. Cl. CPC H01M 10/056; H01M 10/0525; H01M 2300/0068; H01M 2300/0082; H01M 2300/0091

(57) ABSTRACT

A composite solid electrolyte includes: a sulfide solid electrolyte; and a polymer electrolyte containing a polymer and a lithium imide salt, wherein the content of the lithium imide salt with respect to the polymer electrolyte is 40 mass % or more. A solid-state battery includes the composite solid electrolyte.

### CROSS-REFERENCE TO RELATED APPLICATION

This application is based on and claims priority under 35 USC 119 from Japanese Patent Application No. 2023-031439, filed on Mar. 1, 2023, the disclosure of which is incorporated by reference herein.

### BACKGROUND

### Technical Field

The present disclosure relates to a composite solid electrolyte and a solid-state battery.

### Related Art

In recent years, secondary batteries such as lithium ion secondary batteries have been suitably used as, for example, portable power sources of personal computers, portable terminals and the like, and as power sources for the driving of vehicles such as electric vehicles (EVs), hybrid vehicles (HVs), and plug-in hybrid vehicles (PHVs).

Because an electrolytic solution containing a flammable organic solvent is used in a secondary battery, there is the need for improvements in structures and materials for preventing short-circuiting and for attaching safety devices that reduce a rise in temperature at the time of short-circuiting. In contrast, a solid-state battery, which is formed from a solid material and in which a solid electrolyte layer is used in place of an electrolytic solution, does not use a flammable organic solvent within the battery. Therefore, it is thought that, with solid-state batteries, simplification of safety devices is possible, and the batteries have excellent production costs and mass producibility.

In the field of solid-state batteries, a technique of improving the lithium ion conductivity of a solid-state battery is known which uses a composite solid electrolyte that contains a sulfide solid electrolyte, and a polymer electrolyte that contains a polymer and a lithium imide salt (for example, International Publication (WO) No. 2013/001623).

### SUMMARY

However, in conventional composite solid electrolytes, at the time of storage, the sulfide solid electrolyte and the polymer that is contained in the polymer electrolyte react at a contact surface between the sulfide solid electrolyte and the polymer, and reaction products are generated. The ion conduction paths are obstructed thereby, which tends to decrease the ion conductivity. This phenomenon is more conspicuous when the conventional composite solid electrolytes are stored for a long time at high temperatures (e.g., 3 days at 60° C.). Aforementioned WO 2013/001623 attempts to restrain a decrease in the ion conductivity by using a solid electrolyte that contains a sulfide solid electrolyte substantially free of cross-linked sulfur, and a branched polymer. As described above, various types of research have been carried out in order to restrain a decrease in the ion conductivity in the case of using the composite solid electrolyte layer, but further technological developments are desirable. Thus, in view of the above-described circumstances, the present disclosure provides a composite solid electrolyte and a solid-state battery at which a decrease in the ion conductivity is restrained.

A first aspect of the present disclosure provides a composite solid electrolyte including:
a sulfide solid electrolyte; and
a polymer electrolyte containing a polymer and a lithium imide salt,
in which, in the polymer electrolyte, the content of the lithium imide salt with respect to the polymer is 40 mass % or more.

A second aspect of the present disclosure provides the composite solid electrolyte of the first aspect, in which the polymer electrolyte contains an ethylene oxide-based polymer as the polymer.

A third aspect of the present disclosure provides the composite solid electrolyte of the first or second aspect, in which, in the polymer electrolyte, the content of the lithium imide salt with respect to the polymer is 300 mass % or more.

A fourth aspect of the present disclosure provides the composite solid electrolyte of the first or second aspect, wherein, in the polymer electrolyte, a content of the lithium imide salt with respect to the polymer is from 40 mass % to 900 mass %.

A fifth aspect of the present disclosure provides the composite solid electrolyte of any one of the first to fourth aspects, wherein the volume ratio of the sulfide solid electrolyte with respect to the polymer electrolyte is from 80/20 to 95/5.

A sixth aspect of the present disclosure provides a solid-state battery including the composite solid electrolyte of any one of the first to fifth aspects.

In accordance with the present disclosure, a composite solid electrolyte and a solid-state battery are provided at which a decrease in ion conductivity is restrained.

### DETAILED DESCRIPTION

Embodiments that are examples of the present disclosure are described hereinafter. The description thereof and the Examples exemplify embodiments, and are not intended to limit the scope of the invention.

### <Composite Solid Electrolyte>

A composite solid electrolyte according to the present disclosure contains a sulfide solid electrolyte, and a polymer electrolyte that contains a polymer and a lithium imide salt, wherein the content of the lithium imide salt with respect to the polymer electrolyte is 40 mass % or more.

In accordance with the present disclosure, the ratio of the lithium imide salt with respect to the polymer electrolyte is high. The increase in the concentration of the lithium imide salt relative to the entire composite solid electrolyte strengthen the interaction between the polymer and the lithium imide salt, and lowers the reactivity between the polymer and the sulfide solid electrolyte decreases, thereby reducing the decomposition of the sulfide component in the sulfide solid electrolyte. Therefore, generation of reaction products due to a reaction between the sulfide solid electrolyte and the polymer at a contact surface therebetween is reduced during storage (e.g., 3 days at 60° C.). As a result, the conduction paths are not obstructed by the reaction products, and a decrease in the ion conductivity is reduced.

### [Polymer Electrolyte]

The polymer electrolyte contains a polymer and a lithium imide salt. The polymer is not particularly limited provided that it is a polymer that can dissociate the lithium imide salt. The polymer is preferably a polymer having a polar group in the main chain, and examples thereof include: polyalkylene oxide-based polymers such as polyethylene oxide and polypropylene oxide (among which ethylene oxide-based polymers such as polyethylene oxide are more preferable); nitrile-based polymers such as polyacrylonitrile; ester-based polymers; carbonate-based polymers such as polycarbonate; amide-based polymers; phosphazene-based polymers such as polyphosphazene; siloxane-based polymers such as polydimethylsiloxane; and (meth)acrylic-based polymers. One polymer may be used singly, or two or more polymers may be used in combination.

Among them, the polymer preferably includes a polyalkylene oxide-based polymer, and more preferably includes an ethylene oxide-based polymer, from the standpoint of better restraining a decrease in the ion conductivity.

Ethylene oxide-based polymers mean polymers containing a structural unit derived from ethylene oxide. Polyalkylene oxide-based polymers such as polypropylene oxide mean polymers containing a structural unit derived from an alkylene oxide. Nitrile-based polymers mean polymers containing a structural unit derived from a nitrile group. Ester-based polymers mean polymers containing a structural unit derived from an ester group. Amide-based polymers mean polymers containing a structural unit derived from an amide group. Phosphazene-based polymers mean polymers containing a structural unit derived from a phosphazene group. Carbonate-based polymers mean polymers containing a structural unit derived from a carbonate group. Siloxane-based polymers mean polymers containing a structural unit derived from a siloxane group. (Meth)acrylic-based polymers mean polymers containing at least one of a structural unit derived from a methacrylic acid derivative or a structural unit derived from an acrylic acid derivative.

The ethylene oxide-based polymer may be, for example, a copolymer containing a structural unit derived from ethylene oxide, a structural unit derived from 2-(2-methoxyethyoxy)ethyl glycidyl ether, and a structural unit derived from allyl glycidyl ether.

The ethylene oxide-based polymer may include, for example, a structural unit derived from ethylene oxide, a structural unit derived from an alkylene oxide having from 3 to 12 carbon atoms, a structural unit derived from (2-methoxyethyoxy)ethyl glycidyl ether, and a structural unit derived from an oxirane having an ethylenic unsaturated group.

Examples of the structural unit derived from an alkylene oxide having from 3 to 12 carbon atoms include a structural unit derived from an alkylene oxide such as propylene oxide, butylene oxide, 1,2-epoxydodecane, 1,2-epoxyoctane, 1,2-epoxyheptane, 1,2-epoxyhexane, or 1,2-epoxypentane. The structural unit derived from an alkylene oxide having from 3 to 12 carbon atoms is preferably a structural unit derived from propylene oxide.

Examples of the structural unit derived from an oxirane having an ethylenic unsaturated group include a structural unit derived from allyl glycidyl ether, 4-vinylcyclohexyl glycidyl ether, α-terpinyl glycidyl ether, cyclohexenylmethyl glycidyl ether, p-vinylbenzyl glycidyl ether, allyl phenyl glycidyl ether, vinyl glycidyl ether, 3,4-epoxy-1-butene, 3,4-epoxy-1-pentene, 4,5-epoxy-2-pentene, 1,2-epoxy-5,9-cyclodecane diene, 3,4-epoxy-1-vinylcyclohexene, 1,2-epoxy-5-cyclooctene, glycidyl acrylate, glycidyl methacrylate, glycidyl sorbate, glycidyl cinnamate, glycidyl crotonate, or glycidyl-4-hexenoate. The structural unit derived from an oxirane having an ethylenic unsaturated group is more preferably at least one selected from the group consisting of a structural unit derived from allyl glycidyl ether, a structural unit derived from glycidyl acrylate and a structural unit derived from glycidyl methacrylate.

In the ethylene oxide-based polymer, the molar ratio of the respective structural units is determined from the ¹H-NMR spectrum.

The proportion of the structural unit derived from ethylene oxide in the ethylene oxide-based polymer is preferably 30 mol % or more, and more preferably 45 mol % or more, and even more preferably 60 mol % or more.

The proportion of the structural unit derived from ethylene oxide in the ethylene oxide-based polymer is preferably 100 mol % or less, and more preferably 96 mol % or less, and even more preferably 93.5 mol % or less.

The proportion of the structural unit derived from an alkylene oxide having from 3 to 12 carbon atoms in the ethylene oxide-based polymer may be 0 mol %, or may be 3 mol % or more, or may be 5 mol % or more.

The proportion of the structural unit derived from an alkylene oxide having from 3 to 12 carbon atoms in the ethylene oxide-based polymer may be 30 mol % or less, or may be 20 mol % or less, or may be 10 mol % or less.

The proportion of the structural unit derived from (2-methoxyethyoxy)ethyl glycidyl ether in the ethylene oxide-based polymer may be 0 mol %, or may be 3 mol % or more, or may be 5 mol % or more.

The proportion of the structural unit derived from (2-methoxyethyoxy)ethyl glycidyl ether in the ethylene oxide-based polymer may be 70 mol % or less, or may be 59 mol % or less, or may be 39 mol % or less.

The proportion of the structural unit derived from an oxirane having an ethylenic unsaturated group in the ethylene oxide-based polymer may be 0 mol %, or may be 1 mol % or more, or may be 1.5 mol % or more, or may be 2 mol % or more.

The proportion of the structural unit derived from an oxiranes having an ethylenic unsaturated group in the ethylene oxide-based polymer may be 20 mol % or less, or may be 15 mol % or less, or may be 12 mol % or less.

The ethylene oxide-based polymer may be configured by only a structural unit derived from ethylene oxide, a structural unit derived from an alkylene oxide having from 3 to 12 carbon atoms, a structural unit derived from (2-methoxyethyoxy)ethyl glycidyl ether, and a structural unit derived from oxirane having an ethylenic unsaturated group, or may be configured so as to further include structural units derived from other monomers.

In the ethylene oxide-based polymer, the total molar ratio of the structural unit derived from ethylene oxide, the structural unit derived from an alkylene oxide having from 3 to 12 carbon atoms, the structural unit derived from (2-methoxyethyoxy)ethyl glycidyl ether, and the structural unit derived from an oxirane having an ethylenic unsaturated group, with respect to the entire ethylene oxide-based polymer, is preferably 90 mol % or more, and more preferably 95 mol % or more, and even more preferably 98 mol % or more, and particularly preferably 100 mol %.

The polystyrene-equivalent weight average molecular weight (Mw) that is determined by gel permeation chromatography (GPC) of the polymer is not particularly limited, and, for example, may be 1,000,000 or more, or may be from 1,200,000 to 5,000,000, or may be from 1,500,000 to 3,000,000.

The GPC measurement is carried out at 60° C. by using RID-6A manufactured by Shimadzu Corporation, and Shodex KD-807, KD-806, KD806M and KD-803 columns manufactured by Showa Denko K.K., and DMF as the solvent.

Examples of the lithium imide salt include LiN(Rf₁SO₂)₂, LIN(FSO₂)₂, LiN(Rf₁SO₂)(Rf₂SO₂), lithium bis(pentafluoroethanesulfonyl)imide (LiBETI), and lithium bis(trifluoromethanesulfonyl)imide (LiTFSI). Thereamong, from the standpoint of the battery performances, it is preferable that the lithium imide salt include LiTFSI. One lithium imide salt may be used singly, or two or more lithium imide salts may be used in combination.

### [Sulfide Solid Electrolyte]

The sulfide solid electrolyte preferably contains sulfur (S) as the main anion element, and preferably further contains, for example, Li element, element A and S element.

Element A is at least one selected from the group consisting of P, As, Sb, Si, Ge, Sn, B, Al, Ga and In.

The sulfide solid electrolyte may further contain at least one of O or a halogen element.

Examples of the halogen element (X) include F, Cl, Br, I. The composition of the sulfide solid electrolyte is not particularly limited, and examples include xLi₂S·(100−x)P₂S₅ (70≤x≤80) and yLiI·zLiBr·(100−y−z)(xLi₂S·(1−x)P₂S₅) (0.7≤x≤0.8, 0≤y≤30, 0≤z≤30). The sulfide solid electrolyte may have a composition expressed by the following Formula (1).

Li₄₋ₓGe₁₋ₓPₓS₄(0<x<1) Formula (1)

In Formula (1), at least part of Ge may be substituted with at least one selected from the group consisting of Sb, Si, Sn, B, Al, Ga, In, Ti, Zr, V and Nb. Further, at least part of P may be substituted with at least one selected from the group consisting of Sb, Si, Sn, B, Al, Ga, In, Ti, Zr, V and Nb. Part of Li may be substituted with at least one selected from the group consisting of Na, K, Mg, Ca and Zn. Part of S may be substituted with a halogen, which may be at least one of F, Cl, Br or I.

One sulfide solid electrolyte may be used singly, or two or more sulfide solid electrolytes may be used in combination.

From the standpoint of, for example, the battery performances, the sulfide solid electrolyte is preferably an Li₂S—P₂S₅-based sulfide solid electrolyte. When the sulfide solid electrolyte is an Li₂S—P₂S₅-based sulfide solid electrolyte, reaction products of the polymer and the sulfide solid electrolyte are generated at a contact surface therebetween, and the generation of such reaction products tends to obstruct the conduction paths. However, also in this case, adopting the configuration of the composite solid electrolyte according to the present disclosure restrains a decrease in the ion conductivity.

### [Other Components]

The composite solid electrolyte according to the present disclosure may, as needed, further contain other components than the sulfide solid electrolyte and the polymer electrolyte that contains a polymer and a lithium imide salt, as far as the effects according to the present disclosure are exhibited. Examples of the other components include oxide solid electrolytes, halide solid electrolytes, binders (e.g., rubber-based binders and fluoride-based binders), and conductive aids (e.g., fibrous carbon materials).

### [Properties of Composite Solid Electrolyte Overall]

The content of the lithium imide salt with respect to the polymer (100 parts by mass) in the polymer electrolyte is 40 mass % or more, and, from the standpoint of better restraining a decrease in the ion conductivity, is preferably from 300 mass % to 800 mass %, and more preferably from 650 mass % to 750 mass %.

From the standpoint of the battery performances, the content of the lithium imide salt with respect to the polymer (100 parts by mass) in the polymer electrolyte is preferably 900 mass % or less, and more preferably 800 mass % or less, and even more preferably 750 mass % or less.

From the standpoints of increasing the ion conductivity and better restraining a decrease in the ion conductivity, the volume ratio of the sulfide solid electrolyte with respect to the polymer electrolyte (sulfide solid electrolyte/polymer electrolyte) is preferably from 70/30 to 98/2, and more preferably from 75/25 to 97/3, and even more preferably from 80/20 to 95/5.

### [Method of Producing Composite Solid Electrolyte]

The method of producing the composite solid electrolyte of the present disclosure is not particularly limited, and a known method of producing a solid electrolyte can be used. Examples of methods for producing the composite solid electrolyte of the present disclosure include a method of mixing a polymer electrolyte and a solid electrolyte material together in a solvent so as to prepare a slurry, coating the slurry on a substrate, and thereafter, drying the solvent to form a composite solid electrolyte layer; and a method of joining a polymer electrolyte layer and a sulfide solid electrolyte layer that have been prepared separately, so as to form a composite solid electrolyte layer.

### <Solid-State Battery>

A solid-state battery according to the present disclosure contains the composite solid electrolyte of the present disclosure. For example, the solid-state battery according to the present disclosure includes a positive electrode layer, a negative electrode layer, and a solid electrolyte layer disposed between the positive electrode layer and the negative electrode layer. The solid electrolyte layer contains the composite solid electrolyte of the present disclosure. All-solid-state batteries, in which an inorganic solid electrolyte is used (so that the content of electrolytic solution that serves as an electrolyte is less than 5 mass % of the total amount of electrolytes) are included among solid-state batteries.

In a solid-state battery having an electrode (e.g., a negative electrode, and more specifically, a negative electrode containing silicon) that contains an active material that easily expands and contracts, the sulfide solid electrolyte and the polymer contained in the polymer electrolyte react due to friction or the like in the solid electrolyte layer accompanying expansion/contraction of the electrode, and the ion conductivity after storage becomes lower than that before storage. However, use of the composite solid electrolyte of the present disclosure restrains a decrease in ion conductivity even in such a solid-state battery.

The solid-state battery according to the present disclosure is a solid-state lithium ion secondary battery. Examples of the solid-state battery include a power source of a vehicle, electronic equipment, or an electrical storage device. Examples of vehicles include electric four-wheel vehicles, electric two-wheel vehicles, gasoline-powered vehicles, and diesel-powered vehicles. Examples of electric four-wheel vehicles include battery electric vehicles (BEVs), plug-in hybrid electronic vehicles (PHEVs), and hybrid electronic vehicles (HEVs). Examples of electric two-wheel vehicles include electric motorbikes and electrically assisted bicycles. Examples of electronic equipment include handheld devices (e.g., smartphones, tablet computers, and audio players), portable devices (e.g., notebook computers and CD (compact disc) players), and mobile equipment (e.g., power tools and commercial video cameras). Thereamong, the solid-state battery according to the present disclosure is preferably used as a power source for the driving of hybrid electronic vehicles, plug-in hybrid electronic vehicles, and battery electric vehicles.

### EXAMPLES

### Example 1 to Example 6, and Comparative Example 1 to Comparative Example 3

### (Preparation of Sulfide Solid Electrolyte)

An Li₂S—P₂S₅ glass ceramic containing LiI was prepared by ball-mill mixing and firing.

### (Preparation of Polymer Electrolyte Solution)

An ethylene oxide-based polymer was synthesized by random copolymerization of ethylene oxide (EO), 2-(2-methoxyethoxy)ethyl glycidyl ether (EM), and allyl glycidyl ether (AGE). The obtained ethylene oxide-based polymer had a weight average molecular weight of 2,370,000, and the molar ratio EO/EM/AGE of the monomers was 81.8/16.2/2.0. The ethylene oxide-based polymer was dissolved in acetonitrile together with LiTFSI, and a polymer electrolyte solution was prepared such that the mass ratio of the ethylene oxide-based polymer (PEO) and the LiTFSI (PEO/LiTFSI) was the ratio listed in Table 1. The weight average molecular weight and the molar ratio of the polymer were values measured by the above-described methods.

### [Synthesis Example of Polymerization Catalyst]

10 parts by mass of tributyltin chloride and 35 parts by mass of tributyl phosphate were placed in a three-necked flask equipped with a stirrer, a thermometer and a distillation device. While stirring in a nitrogen gas stream, heating was carried out for 20 minutes at 250° C., and the distillate was distilled-off, and a solid, condensed substance was obtained as the residual material. The obtained condensed substance was used as the polymerization catalyst in the following Polymerization Example 1.

### [Polymerization Example 1, Polymer 1]

The interior of a four-necked flask, which was made of glass and had an internal capacity of 3 L, was replaced with nitrogen. 1 part by mass of the condensed substance that was obtained in the Synthesis Example of Polymerization Catalyst, 114 parts by mass of glycidyl ether compound (a) that was adjusted to a moisture content of 10 ppm or less, 10 parts by mass of allyl glycidyl ether, 0.10 parts by mass of n-butanol, and 1000 parts by mass of n-hexane serving as a solvent were charged into the flask. While the polymerization rate of compound (a) was tracked by gas chromatography, 136 parts by mass of ethylene oxide was added at an appropriately controlled rate. The polymerization temperature at this time was made to be 20° C., and the reaction was carried out for 10 hours. The polymerization reaction was stopped by adding 1 mL of methanol. After the polymer was collected by decantation, the polymer was dried for 24 hours at 40° C. under ordinary pressure, and was further dried for 10 hours at 45° C. under reduced pressure, and 210 parts by mass of the polymer were obtained. The molar ratio of the obtained polymer was ethylene oxide/diethylene glycol methyl glycidyl ether/allyl glycidyl ether (i.e., EO/EM/AGE)=81.8/16.2/2.0 (mol %), and the weight average molecular weight was 2,370,000.

### (Preparation of Composite Solid Electrolyte)

The polymer electrolyte solution was placed in a mortar and dried for 30 minutes on a hot plate of 100° C., to volatilize the solution. A sulfide solid electrolyte was mixed together therewith such that the volume ratio of the sulfide solid electrolyte and the polymer electrolyte was that listed in Table 1, whereby the composite solid electrolyte of each of the examples was prepared.

### <Evaluation of Conductivity Maintenance Rate Before and After High-Temperature Storage>

### (Measurement of Conductivity Before High-Temperature Storage)

Within a glove box of a dew point of −80° C., 100 mg of the composite solid electrolyte was weighed-out and placed in a cylinder made of Macor (registered trademark) and pressed at a pressure of 6 ton/cm². Both ends of the obtained pellet were nipped by pins made of SUS, and restraining pressure was applied to the pellet by fastening by bolts, whereby a cell for evaluation was obtained. The ion conductivity at 25° C. of the cell for evaluation was calculated by the AC impedance method. In the measuring, the SOLARTRON 1260 was used, and the applied voltage was set at 10 mV, and the measurement frequency band was set at 0.1 Hz to 1 MHz. The results are shown in Table 1.

(Measurement of Conductivity after High-Temperature Storage)

A storage test on the cell for evaluation of each example was carried out by leaving the cell for evaluation within a glove box for 3 days at 60° C. At the cell for evaluation of each example after the storage test, the ion conductivity was measured by the above-described method, so that the ion conductivities before and after storage were obtained. The results are shown in Table 1.

TABLE 1

| | content (mass %) of lithium | | | |
|---|---|---|---|---|
| | imide salt with respect to | volume ratio (sulfide solid | conductivity (mS/cm) | |
| | polymer in polymer | electrolyte/polymer | before | after |
| | electrolyte | electrolyte) | storage | storage |
| Comparative | 39 | 95:05 | 1.55 | 1.37 |
| Example 1 | | | | |
| Comparative | 39 | 90:10 | 0.96 | 0.81 |
| Example 2 | | | | |
| Comparative | 39 | 80:20 | 0.33 | 0.27 |
| Example 3 | | | | |
| Example 1 | 300 | 95:05 | 2.83 | 2.89 |
| Example 2 | 300 | 90:10 | 1.64 | 1.73 |
| Example 3 | 300 | 80:20 | 0.70 | 0.71 |
| Example 4 | 700 | 95:05 | 2.24 | 2.75 |
| Example 5 | 700 | 90:10 | 1.11 | 1.41 |
| Example 6 | 700 | 80:20 | 0.56 | 0.71 |

As shown in Table 1, it is observed that, with the composite solid electrolytes of the Examples, a decrease in the ion conductivity is reduced as compared with the composite solid electrolytes of the Comparative Examples.

What is claimed is:

1. A composite solid electrolyte, comprising:
a sulfide solid electrolyte; and
a polymer electrolyte containing a polymer and a lithium imide salt,
wherein, in the polymer electrolyte, a content of the lithium imide salt with respect to the polymer is 40 mass % or more.

2. The composite solid electrolyte according to claim 1, wherein the polymer includes an ethylene oxide-based polymer.

3. The composite solid electrolyte according to claim 1, wherein, in the polymer electrolyte, a content of the lithium imide salt with respect to the polymer is 300 mass % or more.

4. The composite solid electrolyte according to claim 1, wherein, in the polymer electrolyte, a content of the lithium imide salt with respect to the polymer is from 40 mass % to 900 mass %.

5. The composite solid electrolyte according to claim 1, wherein a volume ratio of the sulfide solid electrolyte with respect to the polymer electrolyte is from 80/20 to 95/5.

6. A solid-state battery, comprising the composite solid electrolyte according to claim 1.
